(19) United States
(12) Patent Application Publication
(10) Pub. No.: US 2013/0031867 A1
(43) Pub. Date: Feb. 7, 2013

(54) SHAKE JIG FOR INSTALLING SHAKE SIDING

(71) Applicants: Dan R. DUQUETTE, Meredith, NH (US); Gerald F. BRIGGEMAN, III, Laconia, NH (US)

(72) Inventors: Dan R. DUQUETTE, Meredith, NH (US); Gerald F. BRIGGEMAN, III, Laconia, NH (US)

(21) Appl. No.: 13/195,458

(22) Filed: Aug. 1, 2011

(51) Int. Cl. E04G 21/14; E04F 21/00; G01D 21/00

(52) U.S. Cl. 52/748.11; 33/647; 52/749.11

(57) ABSTRACT

A shake jig which comprises a base member which supports an adjustable member and a releasable fastener which facilitates releaseable retention of the adjustable member in a desired relative position with respect to the base member. The base member is substantially planar and has a shake shelf for abutting against a surface of a shake to prevent further insertion thereof, between an installed topmost shake and an at least partially overlapped shake, and facilitate desired alignment of the shake jig with respect to the installed topmost shake. At least one projection is formed on a surface of the base member, adjacent a leading end thereof, to facilitate retention of the shake jig following insertion of the base member. The adjustable member has a ledger shelf for engaging with a ledger board to retain the ledger board in a desired horizontal orientation with respect to the shake shelf and to assist with installation of shakes.

### FIELD OF THE INVENTION

The present invention relates to an improved shake jig which facilitates installing shakes to a building while ensuring that the bottom edges of each shake, in a horizontal row, are properly aligned with one another in a substantially horizontal plane and precisely spaced from the previously installed row of horizontal shakes.

### BACKGROUND OF THE INVENTION

A variety of different mechanisms and techniques are currently utilized by carpenters and/or installers when installing shakes, such as cedar shakes and the like, to a side of a building. One common technique is the use of a “snapped” horizontal chalk line extending from one edge of the building to the opposite edge of the building which is used as a guide when installing the shakes to the building. After a horizontal row of shakes is installed on the building using the “snapped” chalk line as a guide, another chalk line is then “snapped” to the side of the building for the next row and so forth until the entire side of the building has been sided with the shakes. This process is repeated for each side of the building. Such technique, although very accurate, is a quite cumbersome and time consuming and generally slows down the installation process of securing shakes to the building.

While there are a variety of other methods and processes which are known and utilized to assist with installing shakes to the siding of a building, lacking is a relatively simple and easy to use device that also reduces the installation time and effort while still, at the same time, assisting with accurate and reliable installation of shakes.

### SUMMARY OF THE INVENTION

Wherefore, it is an object of the present invention to overcome the above noted drawbacks associated with the prior art techniques.

Another object of the present invention is to provide a shake jig which is relatively inexpensive to manufacture and easy to utilize while, at the same time, provides accurate and reliable installation of shakes to a side of a building.

A further object of the present invention is to provide a shake jig which is easy to insert between adjacent overlapped horizontal rows or layers of installed shakes so as to facilitate reliable retention of the shake jig to a wall of a building while also being easy to remove from the adjacent rows or layers of shakes, following installation of a desired section of shakes.

Yet another object of the present invention is to provide a shake jig with an adjustability feature which provides the installer with the ability to readily compensate for any unevenness of the shakes, the building and/or any other imperfections which are prevalent in a building or a structure and hinder accurate installation of shakes to a building.

A still further object of the present invention is to permit adjustment of the relative position of the ledger shelf, relative to the shake shelf, to compensate for any unevenness of the shakes, the building and/or any other imperfections which are prevalent in a building or structure.

Yet another object of the present invention is to substantially double the installation speed of shakes, by using the shake jig, while still maintaining accurate installation of the shakes.

A still further object of the present invention is to provide a shake jig that may be used for installing either wood, slate or composite shakes and shingles as either a siding and a roofing.

The present invention also relates to a shake jig for assisting with installation of shakes, the shake jig comprising a base member supporting an adjustable member and a releasable fastener facilitating releaseable retention of the adjustable member in a desired relative position with respect to the base member; the base member being substantially planar and having a shake shelf for abutting against a surface of a shake to prevent further insertion of the base member, between an installed topmost shake and an at least partially overlapped shake, and facilitating desired alignment of the shake jig with respect to the installed topmost shake; at least one projection formed on a surface of the base member, adjacent a leading end thereof, to facilitate retention of the shake jig following insertion of the base member between the installed topmost shake and the at least partially overlapped shake; and the adjustable member having a ledger shelf for engaging with a ledger board and retaining the ledger board in a desired horizontal orientation with respect to the shake shelf and to assist with installation of shakes.

The present invention also relates to a system for installing shakes on a building, the system comprising a ledger board; a shake jig for assisting with installation of shakes, the shake jig comprising a base member supporting an adjustable member and a releasably fastener facilitating releaseable retention of the adjustable member in a desired relative position with respect to the base member; the base member being substantially planar and having a shake shelf for abutting against a surface of a shake to prevent further insertion of the base member, between an installed topmost shake and an at least partially overlapped shake, and facilitate desired alignment of the shake jig with respect to the installed topmost shake; at least one projection formed on a surface of the base member, adjacent a leading end thereof, to facilitate retention of the shake jig following insertion of the base member between the installed topmost shake and the at least partially overlapped shake; and the adjustable member having a ledger shelf for engaging with the ledger board and retaining the ledger board in a desired horizontal orientation with respect to the shake shelf and assisting with installation of shakes.

The present invention also relates to a method of installing shakes to a building via a ledger board and first and second shake jigs with each of the first and the second shake jigs comprising a base member supporting an adjustable member and a releasable fastener for facilitating releaseable retention of the adjustable member in a desired relative position with respect to the base member; the base member being substantially planar and having a shake shelf for abutting against a surface of a shake to prevent further insertion of the base member, between an installed topmost shake and an at least partially overlapped shake, and facilitating desired alignment of the shake jig with respect to the installed topmost shake; at least one projection being formed on a surface of the base member, adjacent a leading end thereof, to facilitate retention of the shake jig following insertion of the base member between the installed topmost shake and the at least partially overlapped shake; and the adjustable member having a ledger shelf for engaging with the ledger board and retaining the ledger board in a desired horizontal orientation with respect to the shake shelf and assisting with installation of shakes, the method comprising the steps of inserting a substantially planar leading end of the first shake jig between an installed topmost shake and an at least partially overlapped shake; inserting a substantially planar leading end of the second shake jig between another installed topmost shake and another at least partially overlapped shake such that the first shake jig is spaced from the second shake jig; supporting the ledger board on the ledger shelf of each of the first and the second shake jigs; arranging shakes to be installed on a top surface of the ledger board; and securing the shakes, arranged on the top surface of the ledger board, to the building.

### BRIEF DESCRIPTION OF THE DRAWINGS

The invention will now be described, by way of example, with reference to the accompanying drawings in which:

FIG. 1 is a diagrammatic perspective view of the shake jig according to the present invention;

FIG. 2 is a front elevational view thereof;

FIG. 3 is a side left elevational view thereof;

FIG. 4 is a side left elevational view showing engagement of the shake jig with both a shake and a ledger board;

FIG. 5 is a cross-sectional view along section line of 5-5 of FIG. 2;

FIG. 5A is a cross-sectional view along section line of 5-5 of FIG. 2 showing a further embodiment for guiding the adjustable member;

FIG. 6 shows a pair of spaced apart shake jigs supported by a pair of installed shakes with a ledger board being supported by and extending between the pair of shake jigs with a row of shakes, to be installed, resting on a top surface of the ledger board; and

FIG. 7 is a diagrammatic side left elevational view showing engagement of the shake jig between a pair of adjacent overlapped rows of shake with a ledger board being supported by the ledger board.

FIG. 8 is diagrammatic perspective view of a second embodiment of the shake jig according to a of the present invention;

FIG. 9 is a front elevational view thereof;

FIG. 10 is a side left elevational view thereof;

FIG. 11 is a exploded view thereof;

FIG. 12 is a detailed view of the area of FIG. 9 circumscribed by circle A.

FIG. 13 shows a pair of the spaced apart shake jigs depicted in FIG. 8 supported by a pair of installed shakes with a ledger board being supported by and extending between the pair of shake jigs with a row of shakes, to be installed, resting on a top surface of the ledger board; and

FIG. 14 is a diagrammatic side left elevational view showing engagement of a shake jig in FIG. 13 between a pair of adjacent overlapped rows of shake with a ledger board being supported by the ledger board.

### DETAILED DESCRIPTION OF THE INVENTION

Turning now to FIGS. 1-3,5 and 5A, a detailed description concerning the various components of the shake jig 2 will now be provided. As can be seen in those Figures, the shake jig 2 generally comprises a base member 4 which supports and adjustable member 6 which is movable/slidable relative to the base member 4. A releasable fastener, e.g., a wing nut or nut 8 which is secured to a threaded shaft 9, facilitates releasably securing of the adjusted position of the adjustable member 6 relative to the base member 4.

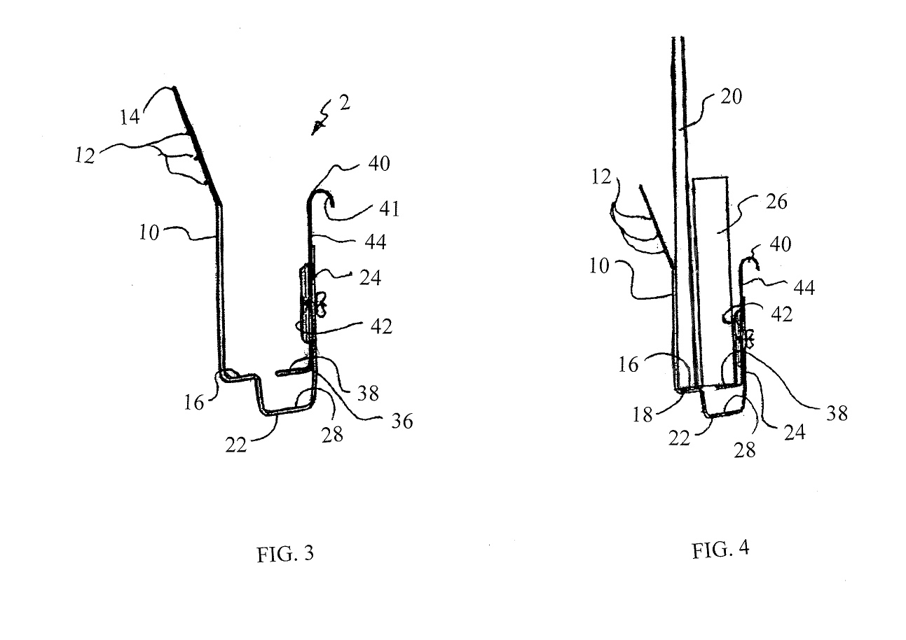

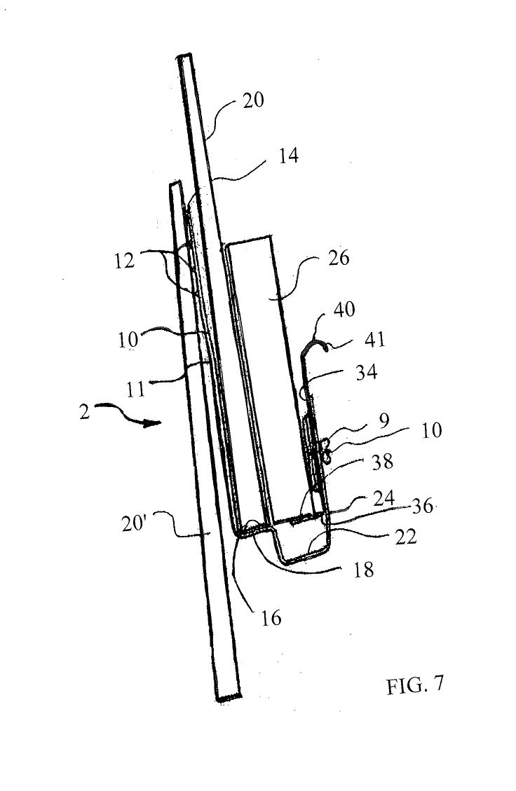

As can be seen if FIG. 3, a first section of the base member 4 is generally L-shaped and comprises an elongate clamping leg 10 which has a slight bend or camber 11 along its length adjacent a leading end 14 thereof, the purpose of which will become apparent in view of the following description. Due to the bend or camber 11 of the clamping leg 10, once the clamping leg 10 is inserted between an installed topmost shake 20 and an at least partially overlapped shakes 20′—as described below in further detail—the camber 11 of the clamping leg 10 is forced into a substantially planar configuration (see FIG. 7) and this straightening of the clamping leg 10, in turn, assists the clamping leg 10 with generating sufficient friction and/or pressure, between the topmost shake 20 and the at least partially overlapped shakes 20′, so as to securely retain the shake jig 2 in its installed position, between such pair of partially overlapped shakes 20, 20′, during use of the shake jig(s) 2.

To further assist with securely retaining the shake jig 2, between the topmost shake 20 and the at least partially overlapped shakes 20′, a plurality of protrusions or gripping features 12 are formed on an rearwardly facing surface 15 adjacent a leading end 14 of the clamping leg 10. The plurality of protrusions or gripping features 12 facilitate retention of the shake jig 2 in the installed position shown in FIGS. 6 and 7. Preferably between two to about twenty or so separate spaced apart protrusions or gripping features 12 are provided on the rearwardly facing surface 15 of the clamping leg 10. The plurality of protrusions or gripping features 12 only project a small distance, e.g., between about 0.005 of an inch to about 0.250 of an inch and more preferably about 0.063 inches or so, from the outwardly facing surface 15 of the clamping leg 10 so as not to hinder insertion of the shake jig 2, between the topmost shake 20 and the at least partially overlapped shakes 20′, but still assist with secure retention of the shake jig 2.

The opposite end of the clamping leg 10 terminates in a sharp substantially right angle bend and this bent section of the base member 4 forms a shake shelf 16 which facilitates abutting the shake jig 2 against a lower downwardly facing surface 18 of the topmost installed shake 20, of a pair of partially overlapped shakes 20, 20′, following installation of the shake jig 2 in the position shown in FIGS. 6 and 7.

A generally J-shaped section 22 is integrally formed with and interconnects a lateral edge of the shake shelf 16 with a substantially planar support leg 24. The support leg 24 extends generally parallel to a lower section of the clamping leg 10, adjacent the shake shelf 16, but is spaced therefrom by a distance of about ¾ of an inch to about 1¾ of an inch or so and more preferably is spaced therefrom by about 1¼ of an inch or so from one another. Such spacing of the support leg 24 from the clamping leg 10 must be sufficiently to allow a topmost shake 20 as well as a coarse or ledger board 26 to be located therebetween (see FIGS. 4 and 7) while still captively retaining those two components in a secure but releasable fashion. The lower portion of the J-shaped section 22 includes a U-shaped finger grip 28 which facilitates removing or withdrawing the shake jig 2 from the installed position, shown in FIGS. 6 and 7, following installation of a desired section of shakes to the side of the building.

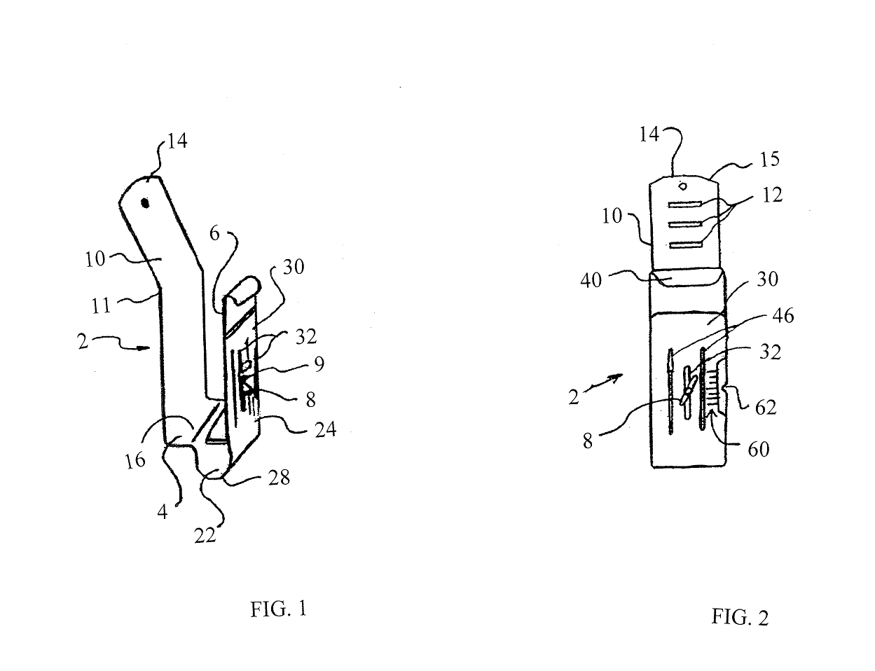

A remote end 30 of the support leg 24 has an elongate slot 32 (see FIG. 2) formed therein and this elongate slot 32 receives one component of the releasable fastener, e.g., the threaded shaft 9, a bolt or a screw, for example. The elongate slot 32 permits sliding movement of the threaded shaft 9, a bolt or a screw, within and along the slot 32, the purpose of which will become apparent in view of the following description. The elongated slot 32 generally has a length of between ⅛ of an inch to about 1 inch or so and more preferably has a length of between ⅜ of an inch to about ¾ of an inch or so.

The mating releaseable fasteners, e.g., the threaded shaft 9, the bolt or the screw, and a mating nut or wing nut 8, for example, facilitate securing the adjustable member 6 to an inwardly facing surface 34 of the support leg 24 at a desired relative position. The end 36 of the adjustable member 6, normally located adjacent the generally J-shaped section 22, has a sharp substantially right angle bend which forms a ledger shelf 38 that extends inwardly toward and generally parallel to the shake shelf 16, but is spaced therefrom by a small distance so as to provide suitable clearance and permit relative sliding movement between the ledger shelf 38 of the adjustable member 6 and the shake shelf 16 of the base member 4. The opposite end 40 of the adjustable member 6 extends generally parallel to the support leg 24 and terminates in a curvature which curves outwardly, away from the clamping leg 10, and this curved end forms a gripping area 41 for a finger of an installer to assist with adjusting the relative position between the adjustable member 6 and the base member 4 as well as facilitates insertion of a ledger board 26 on the ledger shelf 38.

The adjustable member 6 can either support a threaded rod or shaft 9 affixed to a sufficiently flat head 42 with the threaded rod or shaft 9 extending through a bore (not separately labeled) in the adjustable member 6, or alternatively threaded rod or shaft 9 can be fastened, e.g., welded, to an outwardly facing surface 44 of the adjustable member 6 with this threaded rod or shaft 9 being aligned with and extends through the elongate slot 32 and thereby facilitates adjustment of the adjustable member 6 relative to the base member 4.

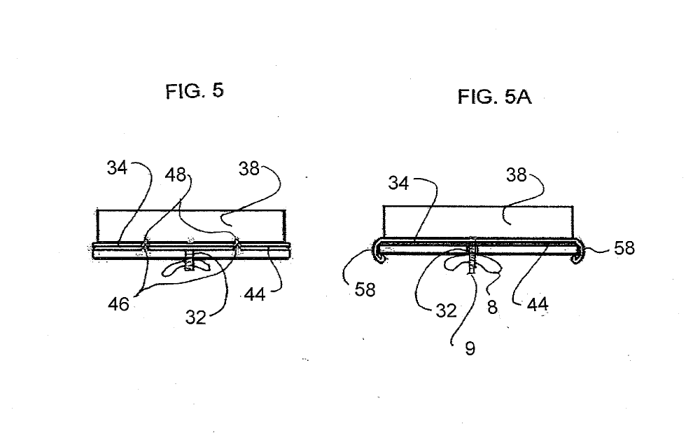

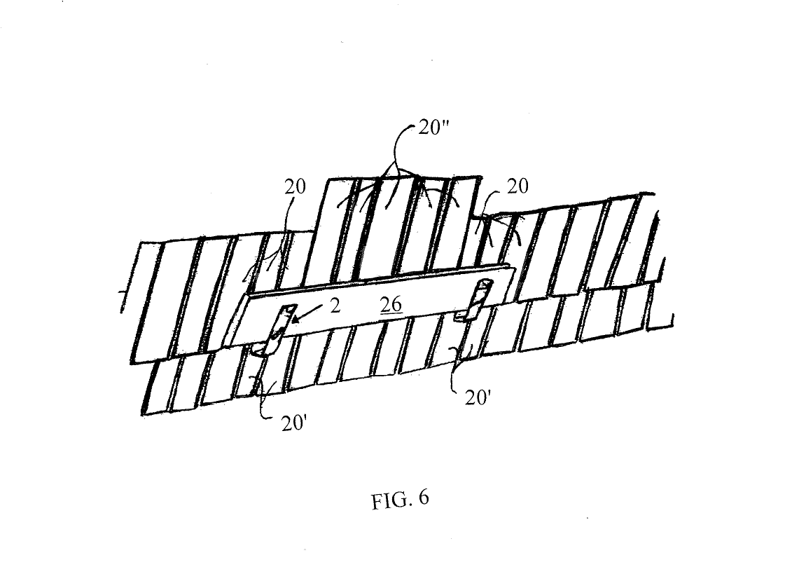

To assist with guiding the adjustable member 6 to and fro along the support leg 24, of the base member 4, so that a longitudinal axis of the adjustable member 6 remains substantially aligned and parallel with a longitudinal axis of the support leg 24 of the base member 4 and the ledger shelf 38 remains substantially parallel to the shake shelf 16, a section of the support leg 24 may be provided with at least one and more preferably a pair of spaced apart guide grooves, recesses and/or protrusions 46 while the adjustable member 6 is provided with one or more mating guide protrusions, grooves and/or recesses 48 (see FIG. 5). Alternatively, as can be seen in see FIG. 5A, one or both lateral sides 58 of the adjustment member 6 may partially wrap around either one or both opposed lateral sides of the support leg 24 to assist with guiding the adjustable member 6 along the support leg 24.

Preferably, as can be seen in FIG. 2, an outwardly facing surface of the support leg 24 of the base member 4, along the elongate slot 32, is provided with measurement grid or scale 60 while the adjustable member 6 carries an index finger or pointer 62, which cooperates with the measurement grid or scale 60, to display the relative position of the ledger shelf 38 with respect to the shake shelf 16 with a “0” position indicating that the shake shelf 16 and the ledger shelf 38 are precisely aligned with one another. The U-shaped finger grip 28, of the lower portion of the J-shaped section 22, provides ample space so that both the ledger shelf 38 and a portion of the ledger board 26 may be at least partially accommodated within the U-shaped finger grip 28 during use of the shake jig 2.

Use of the Shake Jig

With reference to FIGS. 4, 6 and 7, installation and use of the shake jig 2 will now be described. When use of the shake jig 2 is desired, the operator grabs a first shake jig 2 and inserts the leading end 14 of the clamping leg 10 between a topmost shake 20 and a shake 20′ positioned adjacent but installed below and at least partially overlapped by the topmost shake 20 such that the leading end 14 of the clamping leg 10 is sandwiched between those two adjacent shakes 20, 20′. The bend or camber 11 of the clamping leg 10, as well as the one or more plurality of protrusions or gripping features 12, cooperate with one another so as to facilitate retention of the shake jig 2 in the installed position between the two adjacent shakes 20, 20′ as shown in FIG. 7. It is to be appreciated that the shake jig 2 is generally inserted sufficiently so that the bottom lower downwardly facing surface 18 of the shake 20 abuts against the shake ledge 16. This ensures positioning and proper alignment of the shake jig 2 with the topmost shake 20.

Once this is achieved, a second shake jig 2 is positioned, in a similar fashion in a spaced relationship to the first shake jig 2 (e.g., between a pair of adjacent shakes 20, 20′ such that the shake ledge 16 abuts against the respective bottom lower downwardly facing surface 18 of the topmost shake 20 as shown in FIG. 6). Typically the first and the second shake jigs 2 are spaced from one another by a distance of between about 2 feet to about 8 feet or so, depending upon the length of the course or ledge board 26. A ledger board 26 is then inserted and accommodated between the top most shakes 20 and the adjustable members 6 of the pair of spaced apart shake jigs 2 such that the lower edge of the ledger board 26 abuts with and is supported by the ledger shelf 38 of each of the pair of spaced apart shake jigs 2. Thereafter, the installer then places a plurality of the shakes 20″ to be installed along the top surface 27 of the ledger board 26 and the installer is then able to rearrange and/or reposition the shakes 20″ to be installed in a desired order, spacing, position and/or orientation in relation to the previously installed shakes 20 and/or one another in accordance with the conventional siding or roofing practice. Once the shakes 20″ to be installed, are suitably arranged on the top surface 27 of the ledger board 26, the installer then nails, screws or otherwise permanently fastens or secures the shakes 20″ to be installed to the wall in a conventional manner.

Next, the installer removes the ledger board 26 from the pair of spaced apart shake jigs 2 and then places his/her index finger in the finger grip 28, formed in the lower J-shaped section 22 of each shake jig 2 and tugs in a vertically downward direction so that the clamping leg 10 is retracted and removed from its installed location between the pair of adjacent overlapped shakes 20, 20′. Once this occurs, the installer then repeats the above procedure by reinserting the first and the second shake jigs 2 in a sufficiently spaced relationship from one another at a different location along the wall of the building being sided, as described above. The process continues until the entire the building is sided with the shakes.

It is to be appreciated that the installer will occasionally, e.g., once every three to seven horizontal rows of installed shakes, run a chalk line from one edge of the building to the opposite edge of the building to ensure that the shake jig 2 is operating properly and no modification to the relative position, between the ledger shelf 38 and the shake shelf 16, is required. However, if the chalk line reveals any discrepancy, the installer can then adjust the relative position/orientation of one or both of the adjustment members 6 either to slightly increase or decrease the spacing between horizontal rows of shakes 20 and thereby compensate for any misalignment or installation discrepancies which may have occurred during the previous installation process.

Preferably the shake jig 2 is manufactured entirely from a resilient material such as spring steel, which provides increased resistance to bending and fatigue. It is to be appreciated, however, that alternatively the shake jig 2 can be manufactured from a variety of other materials, other than spring steel, e.g., such as plastic or the like. The important aspect of the shake jig 2 is that it is sufficiently rigid and durable to facilitate retention of the ledger board 26 in a desired horizontal orientation along a side of a building and facilitate support and installation of the shakes 20″ to be installed.

The shake jig 2 typically has a width of between one-quarter of an inch or so to about five inches or so and more preferably has a width of between about one-half of an inch to about two inches. The shake jig 2 preferably has a thickness of between about 1/32 to about ⅛ of an inches and preferably about a 1/16 of an inch or so. The shake jig 2 typically has an overall length of between about three inches or so to about nine inches or so and more preferably has an overall length of between about five inches to about seven inches or so.

Although the releasable threaded fasteners is generally described as being a combination of a threaded rod or shaft 9 and a wing nut 8, it is to be appreciated that a variety of other kinds and types of conventional and well known releasable fasteners can be employed. The important aspect of the releasable fastener is that it allows adjustment of the relative position of the adjustable member 6, with respect to the base member 4, while still being able to retain those two members 4, 6 in a desired orientation and/or position with respect to one another.

The ledger board 26 preferably has a length of between about one foot to about sixteen feet of so and more preferably has a length of about two feet to about eight feet or so. It is to be appreciated that the ledger board 26 can be manufactured from a variety of other materials such as wood, plastic, metal, etc. According to the shown embodiment of FIGS. 1-7, the ledger board 26 is generally a wooden plank having a thickness of about three-quarters of an inch or so and also have constant desired width, e.g., a width of between about three inches to about 7 inches or so and preferably a width of about three and one half inches. The important aspect of the ledger board 26 is that the two opposed sides thereof be substantially parallel to one another so as to space any supported shakes 20″ to be installed at a desired distance away from the pair of ledger supports carried by the shake jigs 2. It is to be appreciated that the width of the ledger board 26 determines the spacing of the bottom lower downwardly facing surface 18, of the set of the shakes 20″ to be installed, from the bottom lower downwardly facing surface 18 of the previously installed shake 20.

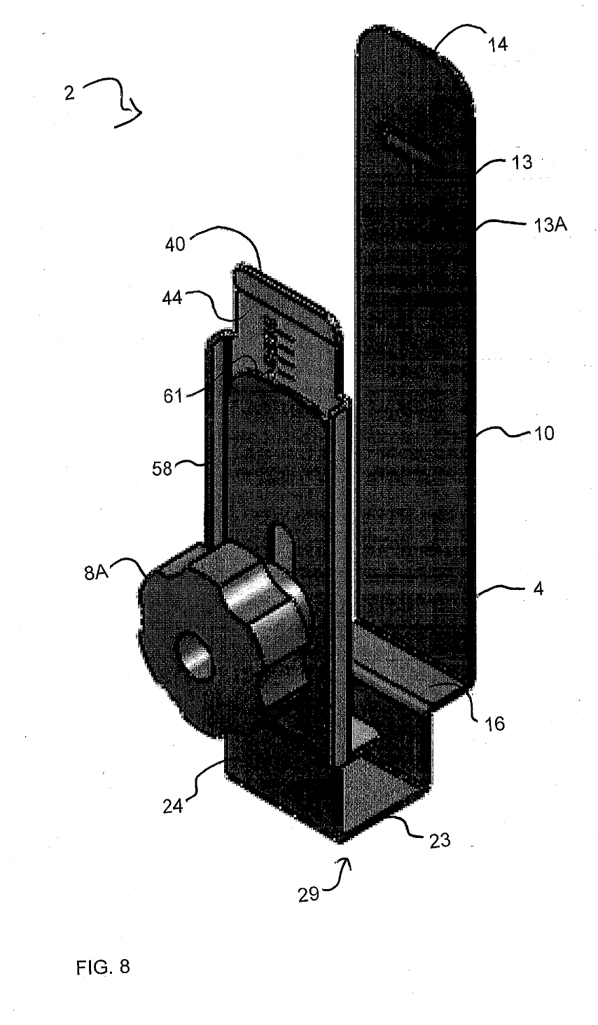

Turning now to FIGS. 8-12, a second embodiment of the invention will be discussed. As will be described in detail below, according to this embodiment, the adjustment scale 60 is moved from the base member 4 to an upper portion of the adjustable member 6. A fluted knob 8A is utilized as the releasable fastener, but it is to be appreciated that other conventional releasable fasteners may also be used. The curved portion 41 of the adjustable member 6, which assisted in the adjustment of the relative position between the adjustable member 6 and the base member 4, is replaced with a flare 43. The contoured section 43 assists in easier insertion of the ledger board. In addition, the bend or camber 11 in the clamping leg 10 is removed so that the clamping leg 10 is substantially planar, and one or more bumps or projections 13 are provided along the inward facing surface 13A of the clamping leg 10, or possibly the opposed outwardly facing surface of the clamping leg 10. This embodiment may be used not only with wooden, but also with composite wood, slate or composite slate shakes and shingles which is applied as either a siding or a roofing.

With reference now to FIGS. 8-14, a detailed description concerning the various components of this embodiment of the shake jig 2 will now be provided. As can be seen in those Figures, the shake jig 2 generally comprises a base member 4 which supports and adjustable member 6 which is movable/slidable relative to the base member 4. A releasable fastener, e.g., a fluted knob 8A secured to a free end of the threaded shaft 9, facilitates releasably securing of the adjusted position of the adjustable member 6 relative to the base member 4.

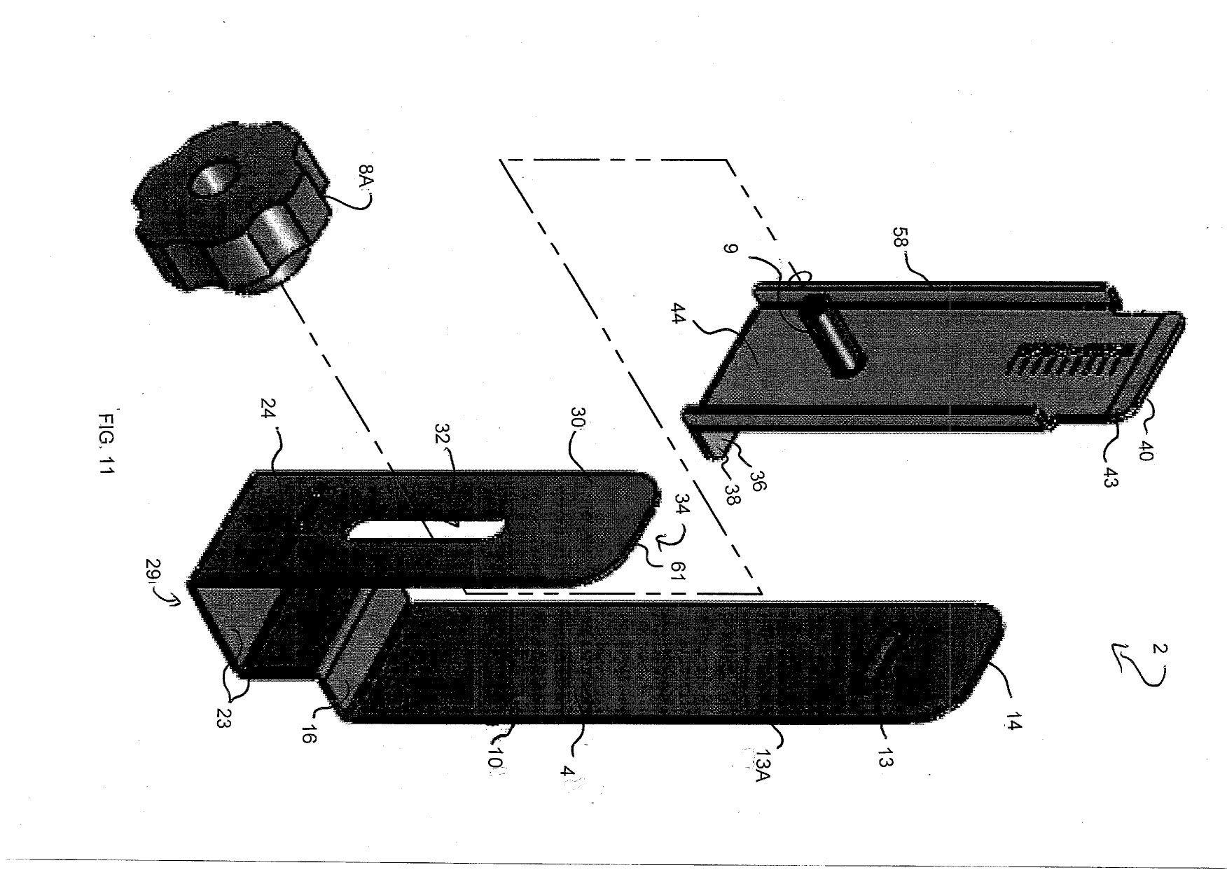

As can be seen in FIG. 10, a first section of the base member 4 is generally L-shaped and comprises an elongate planar clamping leg 10, e.g., the clamping leg 10 does not include any bend or camber 11 along the length thereof. In addition, the clamping leg 10 includes at least one or bump or projection 13 along one surface thereof, preferably the forward facing surface 13A adjacent a leading end 14 thereof, the purpose of which will become apparent in view of the following description. Due to the one or more projections 13 in the clamping leg 10, once the clamping leg 10 is inserted between an installed topmost shake 20 and an at least partially overlapped shakes 20′—as described below in further detail—the at least one projection(s) 13 in the clamping leg 10 biases, pushes or rotates a portion of the topmost shake 20 in a direction substantially normal to the surface, causing a corresponding opposing frictional force/pressure to be exerted on the shake jig 2 by the topmost shake 20 and the at least partially overlapped shakes 20′ so as to securely retain the shake jig 2 in its installed position, between such pair of partially overlapped shakes 20, 20′, during use of the shake jig(s) 2. The at least one projection(s) 13 extends a small distance, e.g., between about 0.005 of an inch to about 0.250 of an inch and more preferably about 0.063 inches or so, from the forward facing surface 13A of the clamping leg 10.

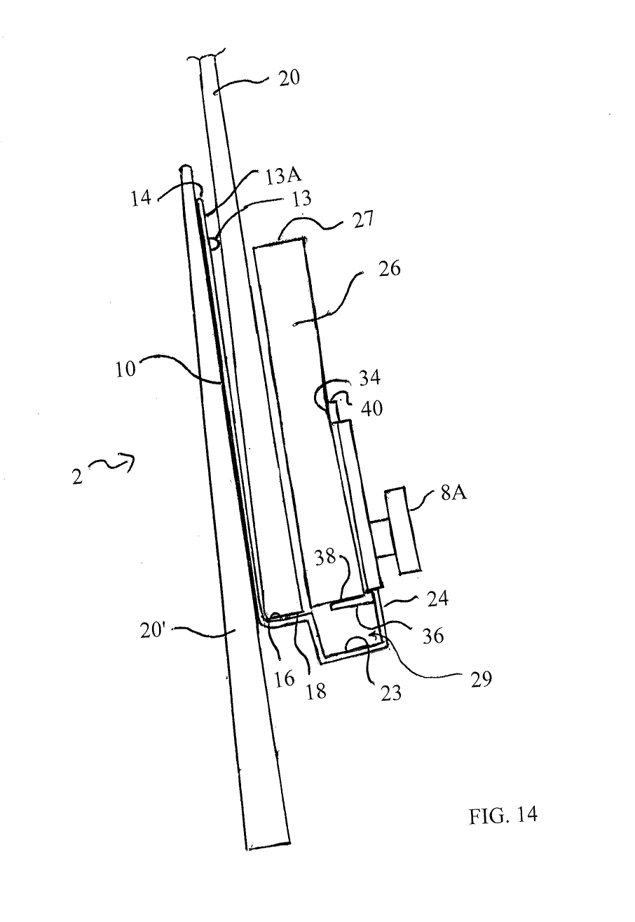

To further assist with securely retaining the shake jig 2, between the topmost shake 20 and the at least partially overlapped shakes 20′, one or more additional protrusions or gripping features 12 may be formed on an opposite rearwardly facing surface 15 adjacent a leading end 14 of the clamping leg 10 or the rearward facing surface 15 may possibly be devoid of any additional protrusion(s) or gripping feature(s), i.e., be flat and smooth. When present, the one or more protrusions or gripping features 12 further facilitate retention of the shake jig 2 in the installed position, as shown in FIGS. 13 and 14. If present, it is to be appreciated that between two to about twenty or so separate spaced apart protrusions or gripping features 12 may be provided on the rearward facing surface 15 of the clamping leg 10. The plurality of protrusions or gripping features 12 only project a small distance, e.g., between about 0.005 of an inch to about 0.250 of an inch and more preferably about 0.063 inches or so, from the rearwardly facing surface 15 of the clamping leg 10 so as not to hinder insertion of the shake jig 2, between the topmost shake 20 and the at least partially overlapped shakes 20′, but still assist with secure retention of the shake jig 2.

The opposite end of the clamping leg 10 preferably terminates in a sharp substantially right angle bend and this bent section of the base member 4 forms a shake shelf 16 which facilitates abutting the shake jig 2 against a lower downwardly facing surface 18 of the topmost installed shake 20 (see FIG. 14), of a pair of partially overlapped shakes 20, 20′, following installation of the shake jig 2 in the position shown in FIGS. 13 and 14. The horizontal length of the bent section of the base member is preferably between 0.4 and 0.6 inches, and most preferably around 0.5 inches.

A generally a L-shaped rectangular bottom section 23 is integrally formed with and interconnects an edge of the shake shelf 16 with an edge of a substantially planar support leg 24. The horizontal length of a base element of the L-shaped bottom section 23 is preferably between 0.65 and 1.0 inches, and most preferably around 0.875 inches. The support leg 24 extends generally parallel to the clamping leg 10, but is spaced therefrom by a distance of about 0.75 inches to about 1.75 inches or so and more preferably is spaced therefrom by about 1.375 inches or so from one another. Such spacing of the support leg 24 from the clamping leg 10 must be sufficiently to allow a topmost shake 20 as well as a coarse or ledger board 26 to be located therebetween (see FIGS. 13 and 14) while still captively retaining those two components in a secure but releasable fashion. The lower portion of the L-shaped bottom section 23 generally forms a rectangular-shaped finger grip 29 which facilitates removing or withdrawing the shake jig 2 from the installed position, shown in FIGS. 13 and 14, following installation of a desired section of shakes to the side or the roof of the building.

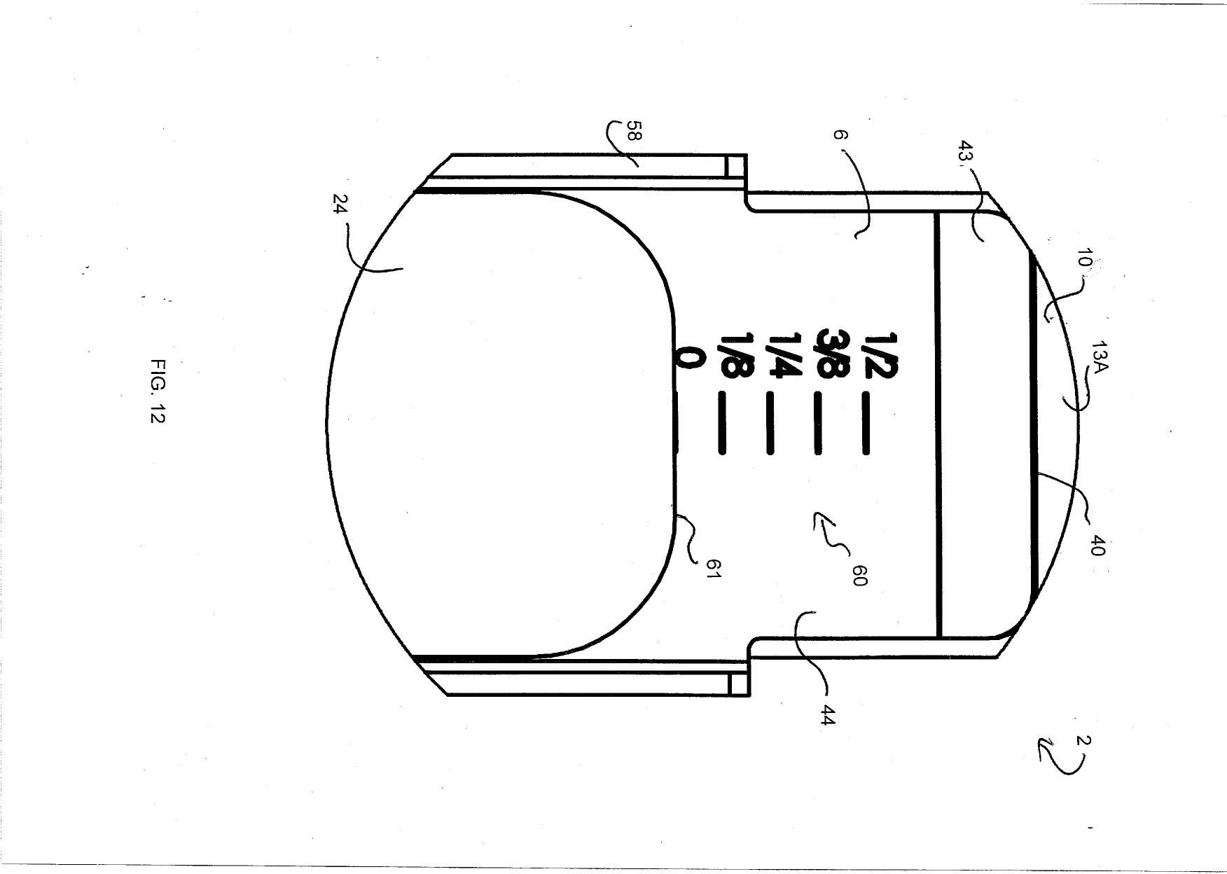

An intermediate section of 30 of the support leg 24 has a preferably centered elongate slot 32 (see FIG. 11) formed therein and this elongate slot 32 receives one component of the releasable fastener, e.g., the threaded shaft 9, a bolt or a screw, for example. The elongate slot 32 permits sliding movement of the threaded shaft 9, the bolt or the screw, within and along the slot 32, the purpose of which will become readily apparent in view of the following description. The elongated slot 32 generally has a length of between ⅛ of an inch to about 1 inch or so and more preferably has a length of between ⅜ of an inch to about ¾ of an inch or so.

The mating releaseable fasteners, e.g., the threaded shaft 9, the bolt or the screw and the mating fluted knob 8A, facilitate securing the adjustable member 6 to a rearward facing surface 34 of the support leg 24 at a desired relative position. The lower end 36 of the adjustable member 6, normally located adjacent the generally L-shaped bottom section 23, includes a sharp substantially right angle bend which forms a ledger shelf 38 (see FIG. 10) that extends toward and generally parallel to the shake shelf 16, but is spaced therefrom by a small clearance distance so as to permit relative sliding movement between the ledger shelf 38 of the adjustable member 6 and the shake shelf 16 of the base member 4. The opposite leading end 40 of the adjustable member 6 extends generally parallel to the support leg 24 and past a remote end of the support leg 24 and terminates as a contoured section 43. The contoured section 43 o the adjustable member 6 flares outwardly, away from the clamping leg 10, and this contoured section generally forms a gripping area for a finger of an installer and thereby assists with adjusting the relative position of the adjustable member 6 relative to the base member 4 as well as facilitating insertion and guidance of a ledger board 26 on the ledger shelf 38.

The adjustable member 6 generally has one end of the threaded rod or the shaft 9 securely affixed or fastened, e.g., welded, to an outwardly facing surface 44 of the adjustable member 6. The threaded rod or shaft 9 is aligned with and extends through the elongate slot 32 of the base member 4, and thereby facilitates relative adjustment of the adjustable member 6 and the base member 4.

To assist with guiding the adjustable member 6 to and fro along the support leg 24 of the base member 4, so that a longitudinal axis of the adjustable member 6 remains substantially aligned and parallel with a longitudinal axis of the support leg 24 of the base member 4, and the ledger shelf 38 remains substantially parallel to the shake shelf 16, one or preferably both lateral sides 58 of the adjustment member 6 are configured so as to partially wrap around either one or both opposed lateral sides of the support leg 24, as shown in FIGS. 8, 10, and 12, and thereby assist with guiding the adjustable member 6 as the adjustable member 6 is vertically adjusted relative to the support leg 24.

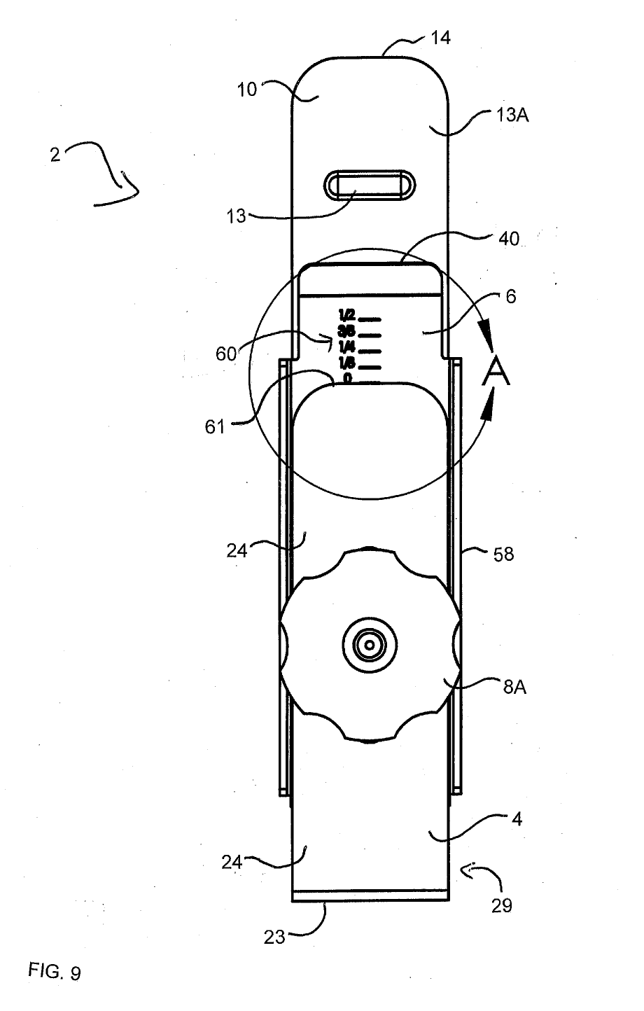

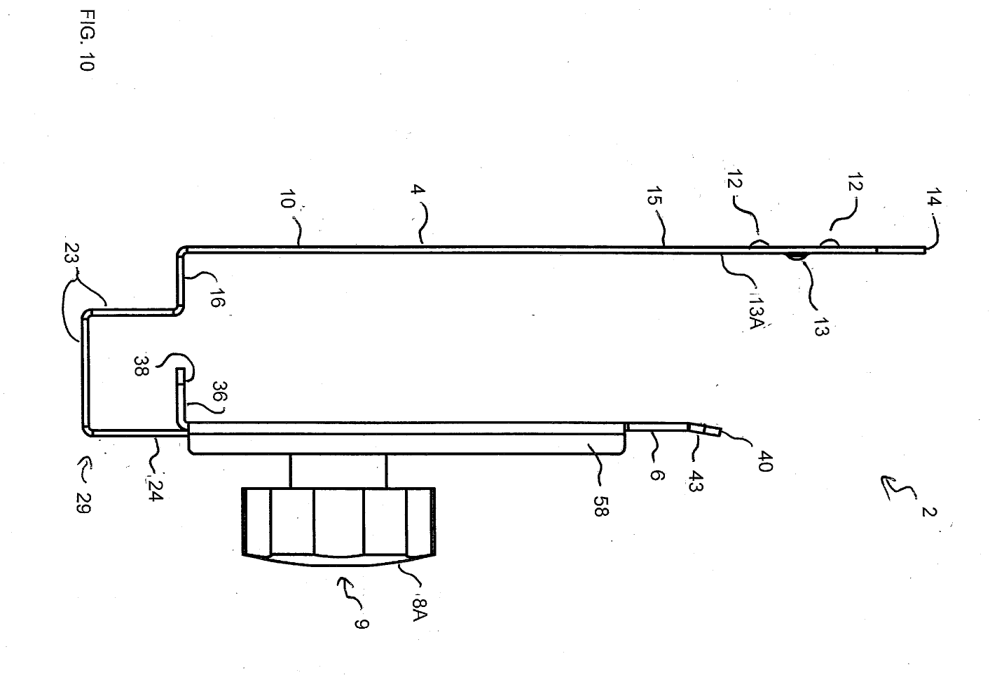

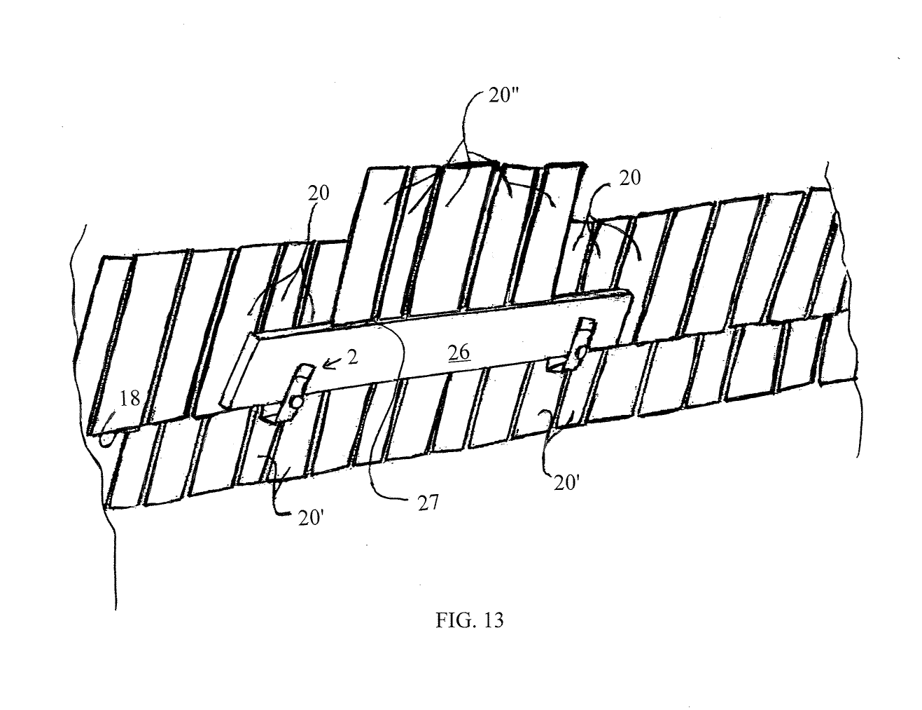

Preferably, as can be seen in FIGS. 9 and 12, the forward facing surface 44 of the adjustable member 6 is provided with measurement grid or scale 60, while a top edge 61 of the support leg 24 acts as an index finger or pointer 62, which cooperates with the measurement grid or scale 60, to display the relative position of the ledger shelf 38 with respect to the shake shelf 16, with the “0” position of the index finger or pointer 62 indicating that the shake shelf 16 and the ledger shelf 38 are precisely aligned with one another. A negative value (e.g., −⅛ of an inch) of the index finger or pointer 62 indicates that the ledger shelf 38 is located that distance below the shake shelf 16 while a positive value of the index finger or pointer 62 (e.g., ⅛ of an inch) indicates that the ledger shelf 38 is located that distance above the shake shelf 16. The rectangular-shaped finger grip 29, of the lower portion of the L-shaped bottom section 23, provides ample space so that both the ledger shelf 38 and a vertically lower portion of the ledger board 26 may be accommodated by the ledger shelf 38 while still providing sufficient room for a finger of an installer (see FIG. 14) to be located within the rectangular-shaped finger grip 29 following use of the shake jig 2.

### Use of the Shake Jig of the Second Embodiment

With reference to FIGS. 13 and 14, installation and use of the shake jig 2 will now be described. When use of the shake jig 2 is desired, the operator or installer takes a first shake jig 2 and inserts the leading end 14 of the clamping leg 10 between a topmost shake 20 and a shake 20′ positioned adjacent but installed below and at least partially overlapped by the topmost shake 20 such that the leading end 14 of the clamping leg 10 is sandwiched between those two adjacent shakes 20, 20′. The at least one projection(s) 13, as well as, potentially, the one or more additional protrusions or gripping features 12, facilitate retention of the shake jig 2 in the installed position between the two adjacent shakes 20, 20′ as shown in FIG. 14. It is to be appreciated that the shake jig 2 is generally inserted sufficiently far so that the bottom lower downwardly facing surface 18 of the shake 20 abuts against the shake ledge 16. This ensures positioning and proper alignment of the shake jig 2 with the topmost shake 20.

Once this is achieved, at least a second shake jig 2 is positioned in a similar fashion (e.g., between a pair of adjacent shakes 20, 20′ such that the shake ledge 16 abuts against the respective bottom lower downwardly facing surface 18 of the topmost shake 20 as shown in FIG. 13), but in a horizontally spaced relationship to the first shake jig 2. Typically the first and the second shake jigs 2 are spaced from one another by a distance of between about 2 feet to about 8 feet or so, depending upon the length and/or the rigidity of the course or ledge board 26. The ledger board 26 is then inserted and accommodated between the top most shakes 20 and the two adjustable members 6 of the pair of spaced apart shake jigs 2 such that the lower edge of the ledger board 26 abuts with and is supported by the ledger shelf 38 of each of the pair of spaced apart shake jigs 2. Thereafter, the installer then places a plurality of the shakes 20″ to be installed along the top surface 27 of the ledger board 26 (see FIGS. 13 and 14) and the installer is then able to rearrange and/or reposition the shakes 20″ to be installed in a desired order, spacing, position and/or orientation in relation to the previously installed shakes 20 and/or one another in accordance with the conventional siding or roofing practice. Once the shakes 20″ to be installed, are suitably arranged on the top surface 27 of the ledger board 26, the installer then nails, screws or otherwise permanently fastens or secures the shakes 20″ to be installed to the wall or the roof in a conventional manner.

Next, the installer removes the ledger board 26 from the pair of spaced apart shake jigs 2 and then places his/her index finger in the rectangular-shaped finger grip 29, formed by the lower L-shaped bottom section 23 of each shake jig 2 and tugs in a vertically downward direction so that the clamping leg 10 is retracted and removed from its temporarily installed location between the pair of adjacent overlapped shakes 20, 20′. Once this occurs, the installer then repeats the above procedure by reinserting the first and the second shake jigs 2 at a sufficiently spaced relationship from one another, at a different location along the wall of the building being sided or the roof being roofed, as described above. The process continues until the entire the building is sided or roofed with the desired shakes and/or shingles.

It is to be appreciated that the installer may occasionally, e.g., once every three to seven horizontal vertical rows of installed shakes or shingles, run a chalk line from one edge of the building to the opposite edge of the building to ensure that the shake jig 2 is operating properly and no modification to the relative spacing or position, between the ledger shelf 38 and the shake shelf 16 is required. However, if the chalk line reveals any discrepancy, the installer can then adjust the relative position/orientation of one or both of the adjustment members 6 either to slightly increase or decrease the spacing between horizontal rows of the shakes 20 and thereby compensate for any misalignment or installation discrepancies which may have occurred during the installation process.

Preferably the shake jig 2 is manufactured entirely from a resilient material such as spring steel, which provides increased resistance to bending and fatigue. It is to be appreciated, however, that alternatively the shake jig 2 can be manufactured from a variety of other materials, other than spring steel, e.g., such as plastic or the like. The important aspect of the shake jig 2 is that the jig 2 be sufficiently rigid and durable to facilitate retention of the ledger board 26 in a desired horizontal orientation along a side of a building and surface or a roof so as facilitate support and installation of the shakes or shingles 20″ to be installed.

The shake jig 2 typically has a width of between one-quarter of an inch or so to about five inches or so and more preferably has a width of between about one-half of an inch to about two inches. The shake jig 2 preferably has a thickness of between about 1/32 to about ⅛ of an inches and preferably about a 1/16 of an inch or so. The shake jig 2 typically has an overall length of between about three inches or so to about nine inches or so and more preferably has an overall length of between about five inches to about seven inches or so.

Although the releasable threaded fastener is generally described as being a combination of the threaded rod or shaft 9 and the fluted knob 8A, it is to be appreciated that a variety of other kinds and types of conventional and well known releasable fasteners can be employed. The important aspect of the releasable fastener is that it allows adjustment of the relative position of the adjustable member 6, with respect to the base member 4, while still being able to retain those two members 4, 6 in a desired orientation and/or position with respect to one another.

The ledger board 26 preferably has a length of between about one foot to about sixteen feet of so and more preferably has a length of about two feet to about ten feet or so. It is to be appreciated that the ledger board 26 can be manufactured from a variety of other materials such as wood, plastic, metal, etc. According to the embodiment of FIGS. 8-14, the ledger board 26 is generally a wooden plank having a thickness of about three-quarters of an inch or so and also have constant desired width, e.g., a width of between about three inches to about 7 inches or so and preferably a width of about three and one half inches. The important aspect of the ledger board 26 is that the two opposed sides thereof be substantially parallel to one another so as to space any supported shakes or shingle 20″ to be installed at a desired distance away from the pair of ledger supports carried by the shake jigs 2. It is to be appreciated that the width of the ledger board 26 determines the spacing of the bottom lower downwardly facing surface 18, of the set of the shakes 20″ to be installed, from the bottom lower downwardly facing surface 18 of the previously installed shake 20.

The term “shake” and “shakes”, as used within this patent application and the accompanying claims, is intended to cover all types of shakes, shingles and other roofing or siding components whether manufactured from wood, composite wood, synthetic material, slate, etc.

Since certain changes may be made in the above described shake jig and installation method, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A shake jig for assisting with installation of shakes, the shake jig comprising:
a base member supporting an adjustable member and a releasable fastener facilitating releaseable retention of the adjustable member in a desired relative position with respect to the base member;
the base member being substantially planar and having a shake shelf for abutting against a surface of a shake to prevent further insertion of the base member, between an installed topmost shake and an at least partially overlapped shake, and facilitating desired alignment of the shake jig with respect to the installed topmost shake;
at least one projection formed on a surface of the base member, adjacent a leading end thereof, to facilitate retention of the shake jig following insertion of the base member between the installed topmost shake and the at least partially overlapped shake; and
the adjustable member having a ledger shelf for engaging with a ledger board and retaining the ledger board in a desired horizontal orientation with respect to the shake shelf and to assist with installation of shakes.

2. The shake jig according to claim 1, wherein the base member is L-shaped and a leading end thereof comprises the substantially planar base member and an opposite end thereof supports the shake shelf.

3. The shake jig according to claim 2, wherein the L-shaped base member comprises a clamping leg and the shake shelf, and the shake shelf extends substantially at a right angle to the clamping leg of the shake jig.

4. The shake jig according to claim 3, wherein at least one protrusion or gripping feature is formed on an outwardly facing surface of the clamping leg, adjacent the leading end thereof, to facilitate retention of the shake jig following insertion of the clamping leg between the installed topmost shake and the at least partially overlapped shake.

5. The shake jig according to claim 3, wherein a plurality of protrusions or gripping features are formed on an outwardly facing surface of the clamping leg, adjacent the leading end thereof, to facilitate retention of the shake jig following insertion of the clamping leg between the installed topmost shake and the at least partially overlapped shake.

6. The shake jig according to claim 1, wherein the base member includes a bottom section which is integrally formed with and interconnects the shake shelf with a substantially planar support leg, a section of the support leg has at least one guide feature, and the adjustable member has at least one mating guide feature which cooperates with the guide feature of the support leg and assists with guiding movement of the adjustable member along the support leg such that a longitudinal axis of the adjustable member remains substantially aligned with and parallel to a longitudinal axis of the support leg and the ledger shelf remains substantially parallel to the shake shelf.

7. The shake jig according to claim 6, wherein at least one lateral side of the adjustable member partially wraps around a lateral side of the support leg to assist with guiding the adjustable member along the support leg such that a longitudinal axis of the adjustable member remains substantially aligned and parallel with a longitudinal axis of the support leg and the ledger shelf remains substantially parallel to the shake shelf.

8. The shake jig according to claim 1, wherein a surface of the adjustable member is provided with a scale and a leading edge of a support leg functions as a pointer, cooperating with the scale, for displaying a relative orientation of the ledger shelf with respect to the shake shelf.

9. The shake jig according to claim 8, wherein when the pointer points to a “0” position of the scale, this pointer position indicates that the shake shelf and the ledger shelf are aligned with one another.

10. The shake jig according to claim 1, wherein a leading end of the adjustable member is contoured away from the base member to facilitate insertion of a ledger board on the ledger shelf and also assist with adjusting a relative position of the adjustable member with respect to the base member.

11. A system for installing shakes on a building, the system comprising:
a ledger board;
a shake jig for assisting with installation of shakes, the shake jig comprising:
a base member supporting an adjustable member and a releasably fastener facilitating releaseable retention of the adjustable member in a desired relative position with respect to the base member;
the base member being substantially planar and having a shake shelf for abutting against a surface of a shake to prevent further insertion of the base member, between an installed topmost shake and an at least partially overlapped shake, and facilitate desired alignment of the shake jig with respect to the installed topmost shake;
at least one projection formed on a surface of the base member, adjacent a leading end thereof, to facilitate retention of the shake jig following insertion of the base member between the installed topmost shake and the at least partially overlapped shake; and
the adjustable member having a ledger shelf for engaging with the ledger board and retaining the ledger board in a desired horizontal orientation with respect to the shake shelf and assisting with installation of shakes.

12. The system according to claim 11, wherein the base member is L-shaped and a leading end thereof comprises the substantially planar base member and an opposite end thereof supports the shake shelf.

13. The system according to claim 12, wherein the L-shaped base member comprises a clamping leg and the shake shelf, and the shake shelf extends substantially at a right angle to the clamping leg of the shake jig.

14. The system according to claim 13, wherein at least one protrusion or gripping feature is formed on an outwardly facing surface of the clamping leg, adjacent a leading end thereof, to facilitate retention of the shake jig following insertion of the clamping leg between the installed topmost shake and the at least partially overlapped shake.

15. The system according to claim 13, wherein a plurality of protrusions or gripping features are formed on an outwardly facing surface of the clamping leg, adjacent a leading end thereof, to facilitate retention of the shake jig following insertion of the clamping leg between the installed topmost shake and the at least partially overlapped shake.

16. The system according to claim 11, wherein the base member includes a bottom section which is integrally formed with and interconnects the shake shelf with a substantially planar support leg, a section of the support leg has at least one guide feature, and the adjustable member has at least one mating guide feature which cooperates with the at least one guide feature of the support leg one and assists with guiding movement of the adjustable member along the support leg such that a longitudinal axis of the adjustable member remains substantially aligned and parallel with a longitudinal axis of the support leg and the ledger shelf remains substantially parallel to the shake shelf.

17. The system according to claim 16, wherein at least one lateral side of the adjustable member partially wraps around a lateral side of the support leg to assist with guiding the adjustable member along the support leg such that a longitudinal axis of the adjustable member remains substantially aligned and parallel with a longitudinal axis of the support leg and the ledger shelf remains substantially parallel to the shake shelf.

18. The system according to claim 11, wherein a surface of the adjustable member is provided with a scale and a leading edge of a support leg functions as a pointer, cooperating with the scale to display a relative position of the ledger shelf with respect to the shake shelf.

19. The system according to claim 18, wherein when the pointer points to a “0” position of the scale, this position indicates that the shake shelf and the ledger shelf are aligned with one another.

20. A method of installing shakes to a building via a ledger board and first and second shake jigs with each of the first and the second shake jigs comprising a base member supporting an adjustable member and a releasable fastener for facilitating releaseable retention of the adjustable member in a desired relative position with respect to the base member; the base member being substantially planar and having a shake shelf for abutting against a surface of a shake to prevent further insertion of the base member, between an installed topmost shake and an at least partially overlapped shake, and facilitating desired alignment of the shake jig with respect to the installed topmost shake; at least one projection being formed on a surface of the base member, adjacent a leading end thereof, to facilitate retention of the shake jig following insertion of the base member between the installed topmost shake and the at least partially overlapped shake; and the adjustable member having a ledger shelf for engaging with the ledger board and retaining the ledger board in a desired horizontal orientation with respect to the shake shelf and assisting with installation of shakes, the method comprising the steps of:
inserting a substantially planar leading end of the first shake jig between an installed topmost shake and an at least partially overlapped shake;
inserting a substantially planar leading end of the second shake jig between another installed topmost shake and another at least partially overlapped shake such that the first shake jig is spaced from the second shake jig;
supporting the ledger board on the ledger shelf of each of the first and the second shake jigs;
arranging shakes to be installed on a top surface of the ledger board; and
securing the shakes, arranged on the top surface of the ledger board, to the building.
